(19) United States
(12) Patent Application Publication
(10) Pub. No.: US 2020/0268029 A1
(43) Pub. Date: Aug. 27, 2020

(54) Method and Agent for Enhancing Performance and Flow of Solids

(71) Applicant: Chris Boyce, Aliso Viejo, CA (US)

(72) Inventor: Chris Boyce, Aliso Viejo, CA (US)

(21) Appl. No.: 16/648,658

(22) PCT Filed: Sep. 18, 2018
(86) PCT No.: PCT/US2018/051603

§ 371 Date: Mar. 18, 2020

Related U.S. Application Data
(60) Provisional application No. 62/560,146, filed on Sep. 18, 2017.

(51) Int. Cl. A23L 29/00; A23K 40/25; A23K 20/158

(52) U.S. Cl. CPC A23L 29/03; A23K 20/158; A23K 40/25

(57) ABSTRACT

A method and flow agent for enhancing performance of solids or aiding solids flow, or both. The method includes providing a solids performance enhancing and flow aid agent, and processing the solids or causing the solids to flow, or both, in the presence of the performance enhancing and powder flow aid agent. The solids performance enhancing and flow aid agent includes a plant oil fraction having iodine value of greater than 55 g I₂/100 g.

### FIELD OF THE INVENTION

The present disclosure relates to a method for enhancing performance of solids and aiding solids flow, comprising adding an agent of the invention to the solids and processing the resulting composition, the agent comprising a plant oil fraction.

The present disclosure also relates to an agent for solids performance and flow enhancement comprising a plant oil fraction.

### BACKGROUND OF THE INVENTION

Processing of solids is often a challenging operation. For example, grinding of solids in mills, including ball, hammer, pebble, rod or roller mills, is an energy intensive process. It is common practice to include grinding aids in this process as the energy requirement for grinding increases as the particle size of the solids decreases during grinding. The flow of the solids is also generally adversely affected by decrease in particle size as the particles tend to agglomerate and cake. Processing and flow aids can ameliorate these effects.

Processing aids have been based on, amongst other materials, mixtures including triethanolamines, glycols and glycerin by-products of biodiesel production. There is a need for an effective, environmentally safe, non-toxic and economical agent for performance enhancement, processing and flow of solids, easily obtainable from sustainable sources.

### SUMMARY OF THE INVENTION

In a broad form of a first aspect, the present disclosure relates to a solids performance enhancing and flow aid agent comprising a plant oil fraction having iodine value of greater than 55 g I₂/100 g, which reduces agglomeration of the solids.

The plant oil may be palm oil, or may be a mixture of plant oils, and the plant oil fraction therefrom may have iodine value in the range from 56 g I₂/100 g to 67 g I₂/100 g.

The plant oil fraction may be palm olein, or may be palm super olein.

The performance enhancing and flow aid agent may include an additive or additives, which may be inorganic. The additive may be sodium silicate or potassium silicate or the like. The additive may also be organic, for example sodium polyacrylate, polycarboxylates, propylene glycol, or may also be any other known grind aid.

The solids with which the performance enhancing and flow agent is used may be organic, inorganic, natural or synthetic, or a mixture thereof. The solids may be industrial, pharmaceutical, food or feed grade materials. The solids may also be polymer precursors.

The agent of the invention may be used with any solids where agglomeration reduction of the solids is beneficial, such as grinding, pouring, transport, storage, extrusion and the like.

In a second aspect, there is provided a method of enhancing performance of solids or aiding solids flow, or both, the method comprising providing a solids performance enhancing and flow aid agent, and processing the solids or causing the solids to flow, or both, in the presence of the performance enhancing and solids flow aid agent, wherein the solids performance enhancing and flow aid agent comprises a plant oil fraction having iodine value of greater than 55 g I₂/100 g.

The plant oil may be palm oil, or may be a mixture of plant oils, and the plant oil fraction therefrom may have iodine value in the range from 56 g I₂/100 g to 67 g I₂/100 g.

The plant oil fraction may be palm olein, or may be palm super olein.

The agent used in the method of the disclosure may include an additive or additives, which may be inorganic. The additive may be, for example, sodium silicate, potassium silicate, or mixtures of the foregoing. The additive may also be organic, for example sodium polyacrylate, polycarboxylates, propylene glycol, or may also be any other known grind aid, or combinations of the foregoing.

The solids used with the performance enhancing and flow agent in the method of the invention may be organic, inorganic, natural or synthetic, or a mixture thereof. The solids may be, for instance, industrial, pharmaceutical, food or feed grade materials. The solids may also be polymer precursors.

The method of the invention seeks to enable processing of solids where agglomeration reduction of the solids is beneficial, such as grinding, pouring, transport, storage, extrusion and the like. The method of the invention may also be used for dust suppression.

In a method of the invention, when the processing is grinding, the agent may be added to the solids at a rate of 0.05 to 2.5 kg/ton solids, or 0.2 to 1.0 kg/ton solids, or more preferably 0.08 to 1.0 kg/ton solids.

In a third aspect, there is provided a solids composition made by the method of the disclosure. This solids composition may further include a grind aid.

It will be appreciated that reference herein to “preferred” or “preferably” is intended as exemplary only.

Throughout this specification, unless the context requires otherwise, the words “comprise,” “comprises” and “comprising” will be understood to imply the inclusion of a stated step or element or group of steps or elements but not the exclusion of any other step or element or group of steps or elements. Thus, use of the term “comprising” and the like indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The articles “a” and “an” are used herein to refer to one or to more than one (i.e., to at least one) of the grammatical object of the article. By way of example, “an element” means one element or more than one element. As used herein, the use of the singular includes the plural (and vice versa) unless specifically stated otherwise.

By “about” is meant a quantity, level, value, number, frequency, percentage, dimension, size, amount, weight or length that varies by as much 15, 14, 13, 12, 11, 10, 9, 8, 7, 6, 5, 4, 3, 2 or 1% to a reference quantity, level, value, number, frequency, percentage, dimension, size, amount, weight or length.

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described.

### BRIEF DESCRIPTION OF THE DRAWING

FIG. 1: Representation of results of comparative study using an agent of the invention in a method of the invention.

### DETAILED DESCRIPTION OF THE INVENTION

Each embodiment described herein is to be applied mutatis mutandis to each and every embodiment unless specifically stated otherwise.

The present disclosure relates to methods and agents for improving performance and flow of solids. As used herein, the terms ‘performance enhancing agent’ or ‘agent of the disclosure’ or ‘agent of the invention’ mean compositions comprising a plant oil fraction that enhance the performance of solids, including but not limited to grinding, extrusion, storage, pouring and the like. As used herein, the term ‘flow aid agent’ means compositions comprising a plant oil fraction that facilitate flow of solids, including before, during or after any of the aforementioned processing of those solids.

The agent of the present disclosure may act as a lubricant or dispersant when dry or wet grinding organic or inorganic materials, synthetic or natural materials, for example flours, calcium carbonate, wollastonite, mica, gypsum, plaster stucco, limestone, feldspar, quartz, sands, cement clinker, silica, oxides, pumice, slag, pearlite, feldspar, barite, calcite, talcum, dolomite, barite, gypsum, clays, fluorite, titanium dioxide, pigments, synthetic minerals, alloys and the like. The plant origin of the agent of the invention has particular advantages, including the ability to use the agent in the grinding of foodstuffs or animal feed as many existing grind aids are not considered food grade. In addition to the foregoing, these agents do not require special handling, regulatory compliance or spill avoidance regulations as they are benign and inert.

Although not wishing to be bound by any particular theory, the performance enhancing and flow aid agent of the invention enhances performance during grinding by decreasing caking and increasing throughput by contributing to modifying the particle size distribution (fineness to which minerals can be effectively milled) of the solids, and improving the dry flow characteristics of the finished materials. The agent of the disclosure reduces the attractive forces of particles of the solid. These attractive forces are the main cause of agglomeration inside a mill, during material transfer and bridging or packing when in storage. While not being bound by any particular theory, it is believed that the agent of the invention coats the particles and neutralizes the surface electrical charges, thereby reducing agglomeration and improving the dry flow characteristics during transport, storage, and handling.

In an embodiment of the invention, the agent of the invention comprises a plant oil fraction having iodine value (IV) of greater than 55 g I₂/100 g. In a further embodiment, the agent comprises a plant oil fraction having iodine value of from 56 g I₂/100 g to 67 g I₂/100 g. Standard measurement of iodine value (IV) as applied to agents of the invention, is described in detail in Example 1 below.

Preferably, the agent of the invention has IV of from 56 g I₂/100 g to 67 g I₂/100 g. Such a composition can be obtained from sustainable oil sources, such as palm oil. An agent of the invention which has an IV in this range has characteristics particularly suited to the agent of the invention, including remaining in the liquid state at room temperature (about 25° C.), having marked heat resistance, and being resistant to degradation under elevated temperatures or mechanical forces, such as those experienced by solids during the grinding process, or during extrusion for example.

The agent of the invention can be used to supplement or replace conventional grind aids, which are often toxic and/or hazardous.

A further embodiment of the invention uses a palm oil fraction as the performance enhancing and flow aid agent. Palm oil is the highest yielding vegetable oil crop, producing more than 30% of world vegetable oil on only 5% of the land used to grow all other vegetable oil crops.

Palm oil is extracted from the fleshy endosperm of the oil palm (Elaeis guineensis). Once extracted, palm oil can be subjected to various refining processes, such as fractionation, refining, bleaching, and deodorization. However, a single fractionation of palm oil provides a fraction known as palm olein in 75-80% yield. A further fractionation provides a fraction known as palm super olein. The characteristics of palm olein and palm super olein are provided in Example 2 below.

Palm olein has an IV of 56 g I₂/100 g to 67 g I₂/100 g. Palm super olein has an IV of 60 g I₂/100 g to 67 g I₂/100 g.

In an embodiment, the agent of the invention can be added to a composition for grinding which includes other components or additives such as lignin sulfonates, plasticizers, dispersants, surfactants, or inorganic additives such as, but not limited to sodium silicate and potassium silicate. These additives can be added in any practicable amount depending on the nature of the solids. An example of an amount is 10 wt % sodium silicate to optimize the properties of the solids which are ground using the agent of the invention. A further example, that of calcium carbonate used for extrusion, is detailed below.

In a further embodiment, the invention provides a method of enhancing performance of solids or aiding solids flow, or both, comprising providing a solids performance enhancing and flow aid agent, and processing the solids or causing the solids to flow, or both, in the presence of the performance enhancing and powder flow aid agent, wherein the solids performance enhancing and flow aid agent comprises a plant oil fraction having iodine value of greater than 55 g I₂/100 g.

In an embodiment, the plant oil fraction used in the method may have iodine value of between 56 g I₂/100 g and 67 g I₂/100 g.

In a further embodiment, the plant oil can be palm oil.

In a preferred embodiment, the method of the invention uses an agent comprising the palm oil fraction palm olein or the palm oil fraction super olein. For example, the agent can be useful in grinding the following materials including, but not limited to: flours, calcium carbonate, wollastonite, mica, gypsum, plaster stucco, limestone, feldspar, quartz, sands, cement clinker, silica, oxides and the like, as previously listed.

The agent of the invention can be used on any solids to improve flow, or suppress dust from granular minerals, for example from 200 mesh to 6 mesh.

The agent and method of the invention are particularly useful where fine solids are used in the environment. For example, calcium carbonate is used in drip irrigation systems to supply calcium to soils. The agent and method of the invention enables grinding of the calcium carbonate without concern for ground water contamination. Current grind aids, such as glycols and triethanolamine, exceed ground water contaminant limits when used in this application.

In another embodiment, in the method of the present invention, the agent of the invention can include other components or additives as listed above.

Grind aid agents facilitate grinding and flow of solids by controlling caking of the solids during and after grinding. In effecting an embodiment of the method of the invention, the agent of the invention can be provided exclusively, or in combination with other grind agents, to the mill feed or directly to the mill in concentrated form or may be diluted with up to 50 wt % water or other suitable diluents, or mixtures thereof. In an embodiment of the method of the invention, the agent can be added to the substrate at a rate of 0.05-2.5 kg/ton substrate, preferably 0.08-1 kg/ton. In an embodiment, the aid agent is added to the substrate at the mill entrance or introduced in the first mill compartment by pump delivery capable of producing the appropriate pressure.

The method of the invention may improve mill efficiency by increasing material transfer, decreasing power demand and improving the classification process of the resultant ground solids. In addition, the flowability of the substrate during and after grinding can also increase throughput rate, and can increase material transfer flow rates resulting in improved production times.

### EXAMPLES

### Example 1: Measurement of Iodine Value

The method of measurement of iodine value (IV) for the purposes of the present invention is ASTM D5768-02(2014), Standard Test Method for Determination of Iodine Value of Tall Oil Fatty Acids, ASTM International, West Conshohocken, Pa., 2014, www.astm.org. This test method covers the Wijs procedure for determination of unsaturation (iodine value) of tall oil fatty acids. The iodine value of a fatty acid product is a measure of the unsaturated fatty acid content of that product and consequently a measure of the ease of oxidation or drying capacity of that fatty acid product. This test method measures the unsaturation as iodine value by addition of an iodine/chlorine reagent. The amount of reagent absorbed is determined by back titrating the excess reagent and comparing it to a blank determination.

### Example 2: Fractionation of Palm Oil

Palm oil has a balanced fatty acid composition in which the level of saturated fatty acids is almost equal to that of the unsaturated fatty acids. Palmitic acid (44%-45%) and oleic acid (39%-40%) are the major component acids, with linoleic acid (10%-11%) and only a trace amount of linolenic acid. The low level of linoleic acid and virtual absence of linolenic acid make the oil relatively stable to oxidative deterioration.

Palm oil is unique among vegetable oils because it has a significant amount of saturated fatty acids (10%-15%) at the two-position of its triglycerides. The appreciable amounts of di-unsaturated and mono-unsaturated triglycerides allow it to be easily separated into two products: palm olein and palm stearin. A wide range of fractions with different properties to suit requirements of various industries is made available through dry fractionation.

Palm olein is the liquid fraction obtained from fractionation of palm oil. The fractionation process involves a physical process of cooling the oil under controlled conditions to low temperatures, followed by filtration of the crystals through membrane press. The liquid olein and solid stearin are products of fractionation.

Palm olein is fully liquid at ambient temperature in warm climates, with iodine value in the range of 55.6 g I₂/100 g to 61.9 g I₂/100 g and a slip melting point of from 19.2° C. to 23.6° C. The high stability of the oil makes it useful for many applications. A high content of tocotrienols is generally present in palm olein, being partitioned preferentially into this phase during fractionation. Sold fat content shows that the oil is liquid at 20° C.−25° C.

Further fractionation of palm olein yields a super olein fraction (iodine value greater than 60). Super olein has cloud points of about 2° C.−5° C. Super olein is also fully liquid at ambient temperature in warm climates, with iodine value in the range of 60.1 to 67.5 g I₂/100 g and a slip melting point of from 12.9° C. to 16.6° C.

### Example 3: Formulation of Agent and Use in Joint Compound

Calcium carbonate is routinely used in joint compound formulations. The formulation used in the example provided herein was made using calcium carbonate ground to a median size of 13 microns using the agent of the invention, exemplified by palm olein (the ‘invention sample’). This ground material was used in a formulation as detailed below, and the performance of the resultant joint compound formulation was compared to that formulated using calcium carbonate ground using triethanolamine as grind aid (the ‘control sample’).

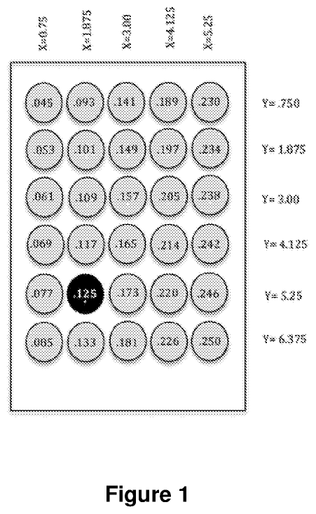

The two joint compound formulations were tested in accordance with ASTM C-474, and a modified cracking test, which exceeds the ASTM C-474 cracking standards. The results of the comparison are represented in FIG. 1.

Joint compound formulation:

### Water—32.71%

### PVAC Resin—2.38%

### Preservative—0.19%

### Calcium Carbonate 325 Mesh—59.47%

### Attapulgite Clay—2.04%

### Mica—1.70%

### Hydroxypropyl Methylcellulose—0.34%

### PVOH S Grade—0.08%

### Pearlite Microspheres—1.09%

Samples were prepared in a laboratory to 510 Brabender units according to ASTM C 474 Section 4. The samples were then thinned to 440 Brabender units to better represent viscosities used by workers in the trade. ASTM C 474 Section 7 ‘Check Cracking For Joint Compound’ requires a joint compound sample to be applied using a ⅛ inch rod over drywall board. The modified cracking test is designed to give a more detailed analytical view of cracking, remove subjectivity, and improve repeatability.

Referring to FIG. 1, one inch round cavities are placed in a half inch thick HDPE template. The HDPE does not absorb moisture like the drywall board and thus optimally shows the propensity of the compound to crack. Each one inch cavity ranges from 0.045 inches to 0.25 inches. There are a total of 30 cavities. The ⅛ inch maximum depth ASTM C-474 calls out for check cracking is represented by the 0.125 inch cavity (shown as the single dark cavity in FIG. 1). Check cracking is measured in each individual cavity.

Referring still to FIG. 1, the cavities are denoted by an X axis and a Y axis. There are 5 cavities along the X axis and 6 cavities along the Y axis. Performance is measured by the maximum depth cavity where no visual check cracking occurs.

The crack suppression of the formulation resulting from use of calcium carbonate processed with an agent of the invention was clearly shown in this experiment: the control sample exceeded ASTM C-474 for check cracking by passing to the cavity of 0.133 inches, while the invention sample exceeded the control sample by three cavities to a depth of 0.157 inches. The implications of this improvement to field applications are significant as the performance of the joint compound is substantially improved.

Additionally, improvements were also seen in tape fiber tare according to testing methods Bond of Paper Joint Tape to Joint Compound Section 15 of ASTM C-474 with the calcium carbonate processed with the agent of the invention.

### Example 4: Use of Agent and Method of Invention for Extrusion

Approximately 80% of the filler used in PVC (polyvinyl chloride) in the USA is calcium carbonate. Calcium carbonate improves the base properties of PVC by adding stiffness to the polymer matrix and improving impact resistance as particle sizes become smaller. Calcium carbonate also improves compounding performance by helping disperse various ingredients into the PVC powder blend and improves processing by making polymer flow more homogenous.

The primary role of calcium carbonate in PVC pipe is cost reduction. At high levels of filler addition, which is where cost reduction becomes significant, key physical properties, such as tensile strength and impact strength, can be adversely affected.

However, a test done with calcium carbonate ground using the agent and method of the present invention (the ‘invention sample’) showed reduced screw pressure in a PVC extrusion plant. This means there is less heat build-up in the extruder which translates to a less brittle product which is less prone to cracking, and has improved impact strength because the extruder runs at a lower temperature.

In addition, PVC manufacturing utilizes expensive twin screw extruders. The higher the friction of material that is processed through the screws, the sooner the expensive screws have to be replaced. Utilizing the invention sample in this application appears to modify the surface tension of the filler to come closer to the surface tension of the PVC melt, reducing the friction during extrusion and prolonging the working life of the screws.

The test results with PVC piping may be extrapolated into other thermoplastic resins with the expectation of improved performance.

1. A solids performance enhancing and flow aid agent comprising:
a plant oil fraction having iodine value of greater than 55 g I₂/100 g, which reduces agglomeration of the solids.

2. The agent of claim 1, wherein the plant oil fraction has iodine value of from 56 g I₂/100 g to 67 g I₂/100 g.

3. The agent of claim 1, wherein the plant oil is palm oil.

4. The agent of claim 1, wherein the plant oil fraction is palm olein.

5. The agent of claim 1, wherein the plant oil fraction is palm super olein.

6. The agent of claim 1, wherein the plant oil fraction is a mixture of plant oils fractions.

7. The agent of claim 1, wherein the agent further comprises at least an inorganic additive.

8. The agent of claim 7, wherein the additive is sodium silicate.

9. The agent of claim 1, wherein the solid is calcium carbonate.

10. The agent of claim 1, wherein the solids are food or feed materials.

11. A solids performance enhancing and flow aid agent comprising:
a plant oil fraction having iodine value of greater than 55 g I₂/100 g, which reduces agglomeration of the solids, wherein the solids are polymer precursors.

12. The agent of claim 1, wherein the performance is grinding.

13. The agent of claim 1, wherein the performance is extrusion.

14. A method of enhancing performance of solids or aiding solids flow, or both, the method comprising:
providing a solids performance enhancing and flow aid agent, and processing the solids or causing the solids to flow, or both, in the presence of the performance enhancing and powder flow aid agent, wherein the solids performance enhancing and flow aid agent comprises a plant oil fraction having iodine value of greater than 55 g I₂/100 g.

15. The method of claim 14, wherein the plant oil fraction has iodine value of from 56 g I₂/100 g to 67 g I₂/100 g.

16. The method of claim 14, wherein the plant oil is palm oil.

17. The method of claim 14, wherein the plant oil fraction is palm olein.

18. The method of claim 14, wherein the plant oil fraction is palm super olein.

19. The method of claim 14, wherein the processing is grinding.

20. The method of claim 19, wherein the agent is provided at a rate of 0.05 to 2.5 kg/ton solids.

21-24. (canceled)
